(19) United States
(12) Patent Application Publication
(10) Pub. No.: US 2026/0045402 A1
(43) Pub. Date: Feb. 12, 2026

(54) COUPLED INDUCTOR

(71) Applicant: CHILISIN ELECTRONICS CORP., Taoyuan City (TW)

(72) Inventors: Jui-Min CHUNG, Taoyuan City (TW); Ming-Chieh CHIU, Taoyuan City (TW)

(21) Appl. No.: 18/981,673

(22) Filed: Dec. 16, 2024

(30) Foreign Application Priority Data
Aug. 12, 2024 (TW) 113130151

(51) Int. Cl. H01F 27/28; H01F 27/24

(52) U.S. Cl. CPC H01F 27/2823; H01F 27/24

(57) ABSTRACT

A coupled inductor includes a magnetic structure, a first winding wire set, a second winding wire set, and an insulating oxide film set. The magnetic structure includes a magnetic core. The first winding wire set is disposed in the magnetic structure and wound outside the magnetic core. The second winding wire set is disposed in the magnetic structure and wound outside the magnetic core. The first winding wire set and the second winding wire set overlap and stagger with each other in a height direction of the magnetic structure. The insulating oxide film set is disposed between the first winding wire set and the second winding wire set to electrically isolate the first winding wire set and the second winding wire set.

### CORSS-REFERENCE TO RELATED APPLICATION

This application claims priority to Taiwan Application Serial Number 113130151, filed August 12, 2024, which is herein incorporated by reference.

### BACKGROUND

### Field of Invention

The present disclosure relates to a passive device, and more particularly, to a coupled inductor.

### Description of Related Art

A coupled inductor connects two coils or inductors through electromagnetic induction. The coupled inductor can reduce the ripple current by coupling two coils, thereby enhancing the conversion efficiency. Therefore, the coupled inductor is suitable for a voltage converter.

Currently, coupled inductors on the market usually stack two layers of winding wires one above the other. However, in this design, the overlapping area of the two winding wires is small, resulting in poor coupling coefficient.

### SUMMARY

Therefore, one objective of the present disclosure is to provide a coupled inductor, in which a first winding wire set and a second winding wire set overlap and stagger with each other in a height direction of a magnetic structure. Such a staggered design can greatly increase an overlapping area between the first winding wire set and the second winding wire set, thereby increasing a coupling coefficient of the coupled inductor.

Another objective of the present disclosure is to provide a coupled inductor, in which an insulating oxide film set is disposed in gaps between the first winding wire set and the second winding wire set to electrically isolate the first winding wire set and the second winding wire set. By adjusting widths and thicknesses of films of the insulating oxide film set, the saturation current and inductance of the coupled inductor can be adjusted to facilitate various applications.

According to the aforementioned objectives, the present disclosure provides a coupled inductor including a magnetic structure, a first winding wire set, a second winding wire set, and an insulating oxide film set. The magnetic structure includes a magnetic core. The first winding wire set is disposed in the magnetic structure and wound outside the magnetic core. The second winding wire set is disposed in the magnetic structure and wound outside the magnetic core. The first winding wire set and the second winding wire set overlap and stagger with each other in a height direction of the magnetic structure. The insulating oxide film set is disposed between the first winding wire set and the second winding wire set to electrically isolate the first winding wire set and the second winding wire set.

According to one embodiment of the present disclosure, the first winding wire set includes a first winding wire layer and a second winding wire layer connected to each other, and the second winding wire set includes a third winding wire layer and a fourth winding wire layer connected to each other. The third winding wire layer is between the first winding wire layer and the second winding wire layer in the height direction of the magnetic structure, and the second winding wire layer is between the third winding wire layer and the fourth winding wire layer in the height direction of the magnetic structure.

According to one embodiment of the present disclosure, the insulating oxide film set includes a first insulating oxide film sandwiched between the first winding wire layer and the third winding wire layer, a second insulating oxide film sandwiched between the third winding wire layer and the second winding wire layer, and a third insulating oxide film sandwiched between the second winding wire layer and the fourth winding wire layer.

According to one embodiment of the present disclosure, a width of the first insulating oxide film is equal to a width of the first winding wire layer and a width of the third winding wire layer, a width of the second insulating oxide film is equal to the width of the third winding wire layer and a width of the second winding wire layer, and a width of the third insulating oxide film is equal to the width of the second winding wire layer and a width of the fourth winding wire layer.

According to one embodiment of the present disclosure, a width of the first insulating oxide film is greater than a width of the first winding wire layer and a width of the third winding wire layer, a width of the second insulating oxide film is greater than the width of the third winding wire layer and a width of the second winding wire layer, and a width of the third insulating oxide film is greater than the width of the second winding wire layer and a width of the fourth winding wire layer.

According to one embodiment of the present disclosure, the first insulating oxide film, the second insulating oxide film, and the third insulating oxide film completely pass through or partially pass through the magnetic core.

According to one embodiment of the present disclosure, the first insulating oxide film, the second insulating oxide film, and the third insulating oxide film completely pass through the magnetic structure.

According to one embodiment of the present disclosure, the first winding wire layer and the second winding wire layer are connected by a first bonding layer, which extends along the height direction of the magnetic structure.

According to one embodiment of the present disclosure, the third winding wire layer and the fourth winding wire layer are connected by a second bonding layer, which extends along the height direction of the magnetic structure.

According to one embodiment of the present disclosure, the first bonding layer is adjacent to the second bonding layer and opposite to the second bonding layer. Between the first bonding layer and the second bonding layer, the first winding wire layer and the fourth winding wire layer are opposite to each other, and the magnetic structure is between the first winding wire layer and the fourth winding wire layer, which are opposite to each other.

### BRIEF DESCRIPTION OF THE DRAWINGS

Aspects of the present disclosure are best understood from the following detailed description in conjunction with the accompanying figures. It is noted that in accordance with the standard practice in the industry, various features are not drawn to scale. In fact, dimensions of the various features can be arbitrarily increased or reduced for clarity of discussion.

FIG. 1 is a schematic three-dimensional perspective view of a coupled inductor in accordance with an embodiment of the present disclosure.

FIG. 2 is a schematic top perspective view of a coupled inductor in accordance with an embodiment of the present disclosure.

FIG. 3 is a schematic side perspective view of a coupled inductor in accordance with an embodiment of the present disclosure.

FIG. 4 is a schematic three-dimensional view of a first winding wire set of a coupled inductor in accordance with an embodiment of the present disclosure.

FIG. 5 is a schematic three-dimensional view of a second winding wire set of a coupled inductor in accordance with an embodiment of the present disclosure.

FIG. 6 is a schematic three-dimensional view of a combination of a first winding wire set and a second winding wire set of a coupled inductor in accordance with an embodiment of the present disclosure.

FIG. 7 is a schematic three-dimensional view of a first winding wire set, a second winding wire set, and an insulating oxide film set of a coupled inductor in accordance with an embodiment of the present disclosure.

### DETAILED DESCRIPTION

The embodiments of the present disclosure are discussed in detail below. However, it will be appreciated that the embodiments provide many applicable concepts that can be implemented in various specific contents. The embodiments discussed and disclosed are for illustrative purposes only and are not intended to limit the scope of the present disclosure. All of the embodiments of the present disclosure disclose various different features, and these features may be implemented separately or in combination as desired.

In addition, the terms "first", "second", and the like, as used herein, are not intended to mean a sequence or order, and are merely used to distinguish elements or operations described in the same technical terms.

The spatial relationship between two elements described in the present disclosure applies not only to the orientation depicted in the drawings, but also to the orientations not represented by the drawings, such as the orientation of the inversion. Moreover, the terms "connected", "electrically connected", or the like between two components referred to in the present disclosure are not limited to the direct connection or electrical connection of the two components, and may also include indirect connection or electrical connection as required.

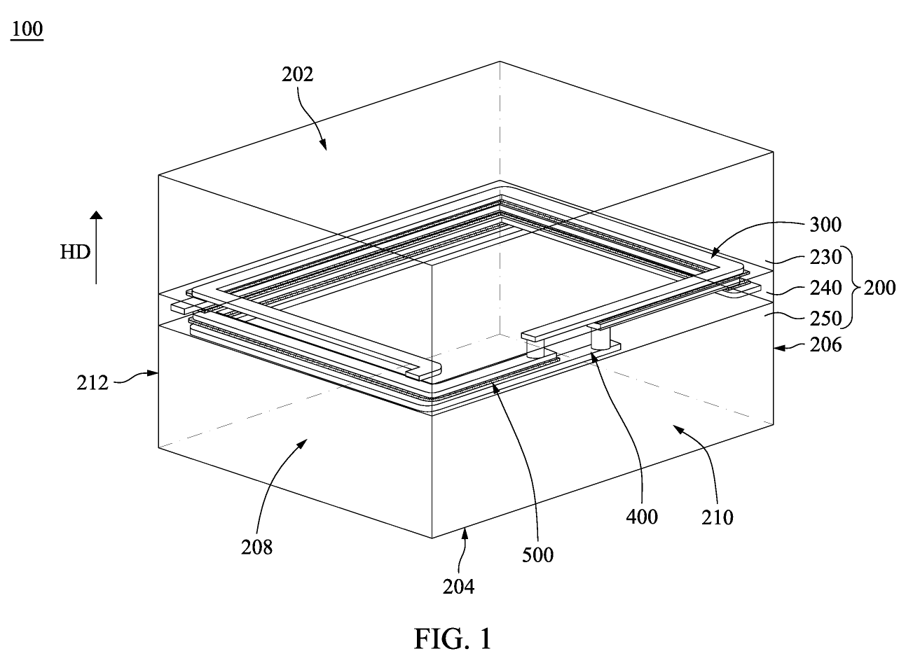

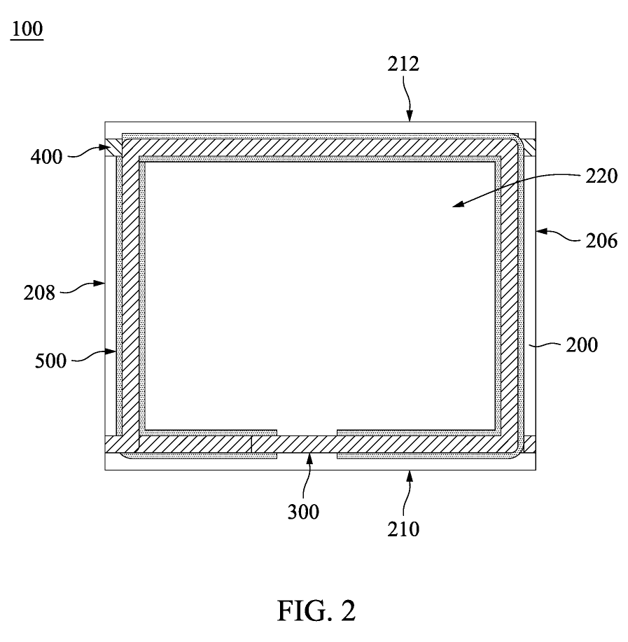

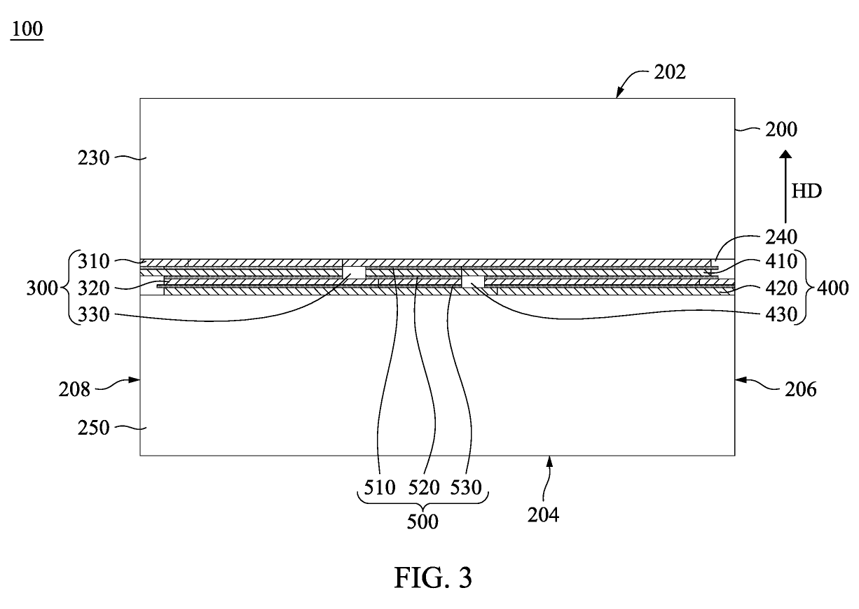

Referring to FIG. 1 to FIG. 3, FIG. 1 to FIG. 3 respectively illustrate a schematic three-dimensional perspective view, a schematic top perspective view, and a schematic side perspective view of a coupled inductor 100 in accordance with an embodiment of the present disclosure. A first winding wire set 300 and a second winding wire set 400 are marked with different oblique lines in FIG. 2 and FIG. 3 to clearly show the first winding wire set 300 and the second winding wire set 400. The coupled inductor 100 has a high coupling coefficient and may be, for example, applied to a multi-phase switching power converter or a trans-inductor regulator. The coupled inductor 100 may mainly include a magnetic structure 200, the first winding wire set 300, the second winding wire set 400, and an insulating oxide film set 500.

In the example shown in FIG. 1, the magnetic structure 200 is a rectangular structure having an upper surface 202 and a lower surface 204 that are opposite to each other, and four side surfaces 206, 208, 210, and 212, in which the upper surface 202 and the lower surface 204 connect the four side surfaces 206, 208, 210, and 212. The upper surface 202 and the lower surface 204 are opposite to each other in a height direction HD of the magnetic structure 200. The shape of the magnetic structure 200 can be designed according to product requirements, and the present disclosure is not limited thereto. For example, the magnetic structure 200 may be a cylindrical structure, an ellipsoid structure, a polygonal columnar structure other than a quadrilateral structure, etc. As shown in FIG. 2, the magnetic structure 200 includes a magnetic core 220 located in a middle region of the magnetic structure 200.

The magnetic structure 200 may be formed by lamination. As shown in FIG. 1 and FIG. 3, in some examples, the magnetic structure 200 includes a first portion 230, a second portion 240, and a third portion 250 stacked in sequence. Materials or particle sizes of the first portion 230, the second portion 240, and the third portion 250 may be the same as each other, or may be different from each other. Thus, magnetic permeabilities of the first portion 230, the second portion 240, and the third portion 250 may be the same as each other, or may be different from each other. The material or the particle size of the first portion 230 may be the same as the material or the particle size of the third portion 250 but different from the material or the particle size of the second portion 240. As a result, the magnetic permeability of the first portion 230 may be the same as the magnetic permeability of the third portion 250 but different from the magnetic permeability of the second portion 240.

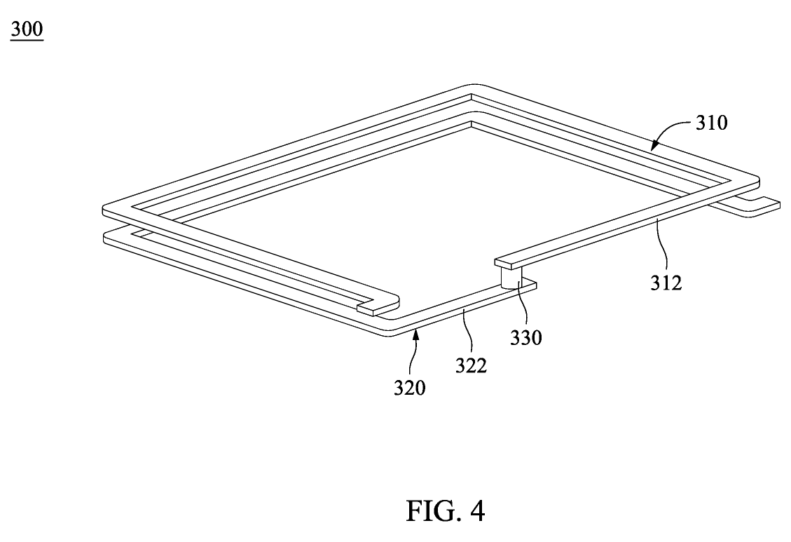

Referring to FIG. 4 simultaneously, FIG. 4 is a schematic three-dimensional view of a first winding wire set 300 of a coupled inductor 100 in accordance with an embodiment of the present disclosure. The first winding wire set 300 is disposed in the magnetic structure 200 and surrounds the magnetic core 220. Specifically, the first winding wire set 300 is embedded inside the magnetic structure 200, and is located between the upper surface 202 and the lower surface 204. The first winding wire set 300 is located in the second portion 240. For example, the first winding wire set 300 may be located in the middle region of the magnetic structure 200 in the height direction HD.

In some examples, as shown in FIG. 3 and FIG. 4, the first winding wire set 300 includes a first winding wire layer 310 and a second winding wire layer 320. In the height direction HD of the magnetic structure 200, the first winding wire layer 310 is located above the second winding wire layer 320. The first winding wire layer 310 and the second winding wire layer 320 respectively surround the magnetic core 220 and are connected to each other to form a first winding turn. For example, each of the first winding wire layer 310 and the second winding wire layer 320 may wind around the magnetic core 220 for nearly one turn, such that the first winding turn approximately winds around the magnetic core 220 two turns. In some examples, the first winding wire set 300 further includes a first bonding layer 330. The first bonding layer 330 extends between the first winding wire layer 310 and the second winding wire layer 320 along the height direction HD of the magnetic structure 200, and two opposite ends of the first bonding layer 330 are respectively bonded to the first winding wire layer 310 and the second winding wire layer 320 to connect the first winding wire layer 310 and the second winding wire layer 320. Shapes and sizes of a winding wire 312 of the first winding wire layer 310 and a winding wire 322 of the second winding wire layer 320 may be the same, and most of the winding wires 312 and 322 can overlap in the height direction HD of the magnetic structure 200. In some examples, the winding wires 312 and 322 have the same width. Materials of the winding wires 312 and 322 may be, for example, metallic conductive materials.

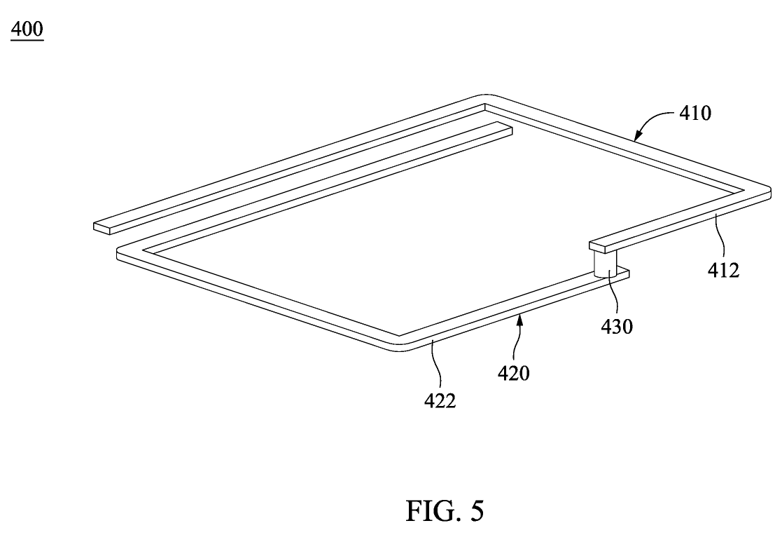

Referring to FIG. 5 simultaneously, FIG. 5 is a schematic three-dimensional view of a second winding wire set 400 of a coupled inductor 100 in accordance with an embodiment of the present disclosure. The second winding wire set 400 is disposed inside the magnetic structure 200, between the upper surface 202 and the lower surface 204, and surrounds the magnetic core 220. The second winding wire set 400 is located in the second portion 240. Similarly, the second winding wire set 400 may be located in the middle region of the magnetic structure 200 in the height direction HD.

In some examples, as shown in FIG. 3 and FIG. 5, the second winding wire set 400 includes a third winding wire layer 410 and a fourth winding wire layer 420. In the height direction HD of the magnetic structure 200, the third winding wire layer 410 is located above the fourth winding wire layer 420. The third winding wire layer 410 and the fourth winding wire layer 420 respectively surround the magnetic core 220 and are connected to each other to form a second winding turn, in which the second winding turn corresponds to the first winding turn. For example, each of the third winding wire layer 410 and the fourth winding wire layer 420 may wind around the magnetic core 220 for nearly one turn, such that the second winding turn approximately winds around the magnetic core 220 two turns. In some examples, the second winding wire set 400 further includes a second bonding layer 430. The second bonding layer 430 extends in the magnetic structure 200 along the height direction HD of the magnetic structure 200, and two opposite ends of the second bonding layer 430 are respectively bonded to the third winding wire layer 410 and the fourth winding wire layer 420 to connect the third winding wire layer 410 and the fourth winding wire layer 420. Shapes of the winding wire 412 of the third winding wire layer 410 and the winding wire 422 of the fourth winding wire layer 420 may be the same, and sizes such as widths and thicknesses of the winding wires 412 and 422 may be the same. Most of the winding wires 412 and 422 can overlap in the height direction HD of the magnetic structure 200. Materials of the winding wires 412 and 422 may be, for example, metallic conductive materials.

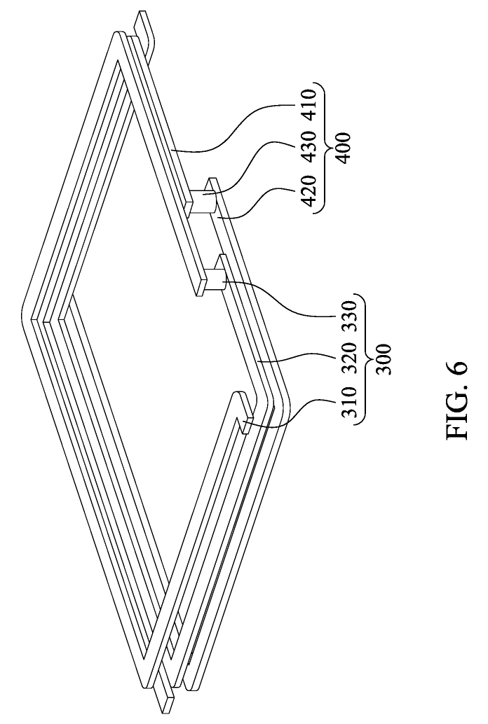

Referring to FIG. 1, FIG. 3, and FIG. 6 simultaneously, FIG. 6 is a schematic three-dimensional view of a combination of a first winding wire set 300 and a second winding wire set 400 of a coupled inductor 100 in accordance with an embodiment of the present disclosure. The first winding wire set 300 and the second winding wire set 400 correspondingly overlap in the height direction HD of the magnetic structure 200, and are arranged staggered with each other. Specifically, in the height direction HD of the magnetic structure 200, the third winding wire layer 410 of the second winding wire set 400 is between the first winding wire layer 310 and the second winding wire layer 320 of the first winding wire set 300, the second winding wire layer 320 is between the third winding wire layer 410 and the fourth winding wire layer 420. That is, along the height direction HD of the magnetic structure 200, the first winding wire layer 310, the third winding wire layer 410, the second winding wire layer 320, and the fourth winding wire layer 420 are arranged in this order.

In the height direction HD of the magnetic structure 200, the first winding wire layer 310 and the second winding wire layer 320 of the first winding wire set 300, and the third winding wire layer 410 and the fourth winding wire layer 420 of the second winding wire set 400 correspondingly overlap and stagger with each other. With such a design, the overlapping area between the first winding wire set 300 and the second winding wire set 400 can be greatly increased, and a coupling coefficient of the coupled inductor 100 can be increased.

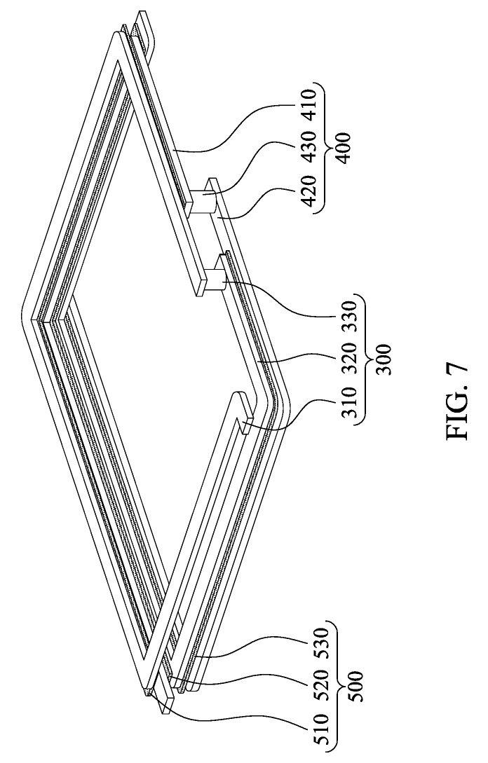

Referring to FIG. 2, FIG. 3, and FIG. 7 simultaneously, FIG. 7 is a schematic three-dimensional view of a first winding wire set 300, a second winding wire set 400, and an insulating oxide film set 500 of a coupled inductor 100 in accordance with an embodiment of the present disclosure. The insulating oxide film set 500 is disposed in magnetic structure 200 and the between the first winding wire set 300 and the second winding wire set 400 to electrically isolate the first winding wire set 300 and the second winding wire set 400, so as to prevent short circuit between the first winding wire set 300 and the second winding wire set 400. Therefore, the insulating oxide film set 500 is located in the second portion 240. The insulating oxide film set 500 may be made of high temperature and high voltage resistant materials, such as glass, ceramics, etc.

In the example shown in FIG. 3 and FIG. 7, the insulating oxide film set 500 includes a first insulating oxide film 510, a second insulating oxide film 520, and a third insulating oxide film 530. In the height direction HD of the magnetic structure 200, the first insulating oxide film 510, the second insulating oxide film 520, and the third insulating oxide film 530 are arranged from top to bottom. As shown in FIG. 3, the first insulating oxide film 510 is sandwiched between the adjacent first winding wire layer 310 and the third winding wire layer 410 to separate the first winding wire layer 310 and the third winding wire layer 410. The second insulating oxide film 520 is sandwiched between the adjacent third winding wire layer 410 and the second winding wire layer 320 to separate the third winding wire layer 410 and the second winding wire layer 320. The third insulating oxide film 530 is sandwiched between the adjacent second winding wire layer 320 and the fourth winding wire layer 420 to separate the second winding wire layer 320 and the fourth winding wire layer 420.

In some examples, as shown in FIG. 7, the first insulating oxide film 510, the second insulating oxide film 520, and the third insulating oxide film 530 are the same as the first winding wire set 300 and the second winding wire set 400, and are open or closed annular structures surrounding the magnetic core 220. In such an example, shapes of the first insulating oxide film 510, the second insulating oxide film 520, and the third insulating oxide film 530 may be the same as shapes of the corresponding winding wire layers separated by them, but sizes of the first insulating oxide film 510, the second insulating oxide film 520, and the third insulating oxide film 530 need to cover the corresponding winding wire layers separated by them to prevent short circuit between adjacent winding wire layers.

In some examples, as shown in FIG. 2, a width of the first insulating oxide film 510 is greater than the widths of the first winding wire layer 310 and the third winding wire layer 410, a width of the second insulating oxide film 520 is greater than the widths of the third winding wire layer 410 and the second winding wire layer 320, and a width of the third insulating oxide film 530 is greater than the widths of the second winding wire layer 320 and the fourth winding wire layer 420. In other examples, the width of the first insulating oxide film 510 is equal to the width of the first winding wire layer 310 and the third winding wire layer 410, the width of the second insulating oxide film 520 is equal to the widths of the third winding wire layer 410 and the second winding wire layer 320, and the width of the third insulating oxide film 530 is equal to the width of the second winding wire layer 320 and the fourth winding wire layer 420. That is, each film of the insulating oxide film set 500, each winding wire layer of the first winding wire set 300, and each winding wire layer of the second winding wire set 400 have the same width and are substantially aligned with each other.

In other examples, each of the first insulating oxide film 510, the second insulating oxide film 520, and the third insulating oxide film 530 is a plate structure, and the first insulating oxide film 510, the second insulating oxide film 520, and the third insulating oxide film 530 are not only located between the adjacent winding wire layers, but also completely or partially pass through the magnetic core 220. In such an example, the first insulating oxide film 510, the second insulating oxide film 520, and the third insulating oxide film 530 may not only pass through the magnetic core 220, but may also completely pass through the magnetic structure 200 and be exposed on the side surfaces 206, 208, 210, and 212 of the magnetic structure 200.

Referring to FIG. 1 and FIG. 7, the first bonding layer 330 of the first winding wire set 300 is adjacent to the second bonding layer 430 of the second winding wire set 400, and is opposite to the second bonding layer 430. In some examples, between the first bonding layer 330 and the second bonding layer 430, the first winding wire layer 310 and the fourth winding wire layer 420 are opposite to each other, and the magnetic structure 200 is between the portions of the first winding wire layer 310 and the fourth winding wire layer 420 that are opposite to each other. In other examples, between the first bonding layer 330 and the second bonding layer 430, in addition to the magnetic structure 200, the insulating oxide film set 500 may also be between the portions of the first winding wire layer 310 and the fourth winding wire layer 420 that are opposite to each other.

The saturation current and the inductance of the coupled inductor 100 can be adjusted by controlling the width and the thickness of the insulating oxide film set 500. As the width of the insulating oxide film set 500 becomes larger, the area of the insulating oxide film set 500 is increased, which reduces the area of the magnetic material and causing the inductance to decrease. Therefore, the width of the insulating oxide film set 500 can be adjusted according to the product application requirements, such that the coupled inductor 100 can be applied in higher-standard circuit designs.

In the manufacturing of the coupled inductor 100, an insulating oxide film and a winding wire layer are sequentially printed, a magnetic material is then printed in the middle area and periphery of the stack of the insulating oxide film and the winding wire layer to form a printed laminate, and the printed laminates are stacked to form a laminate structure. After the laminated structure is cut and sintered, and then electroplated with electrodes, the coupled inductor 100 can be roughly completed.

According to the aforementioned embodiments, one advantage of the present disclosure is that the first winding wire set and the second winding wire set of the coupled inductor of the present disclosure overlap and stagger with each other in the height direction of the magnetic structure. Such a staggered design can greatly increase an overlapping area between the first winding wire set and the second winding wire set, thereby increasing the coupling coefficient of the coupled inductor.

Another advantage of the present disclosure is that the present disclosure can adjust the saturation current and the inductance of the coupled inductor by adjusting the widths and thicknesses of the films of the insulating oxide film set arranged between the first winding wire set and the second winding wire set, which facilitates various applications.

Although the present disclosure has been disclosed above with embodiments, it is not intended to limit the present disclosure. Any person having ordinary skill in the art can make various changes and modifications without departing from the spirit and scope of the present disclosure. Therefore, the protection scope of the present disclosure should be defined by the scope of the appended claims.

What is claimed is:

1. A coupled inductor, comprising:
a magnetic structure comprising a magnetic core;
a first winding wire set disposed in the magnetic structure and wound outside the magnetic core;
a second winding wire set disposed in the magnetic structure and wound outside the magnetic core, wherein the first winding wire set and the second winding wire set overlap and stagger with each other in a height direction of the magnetic structure; and
an insulating oxide film set disposed between the first winding wire set and the second winding wire set to electrically isolate the first winding wire set and the second winding wire set.

2. The coupled inductor of claim 1, wherein the first winding wire set comprises a first winding wire layer and a second winding wire layer connected to each other, the second winding wire set comprises a third winding wire layer and a fourth winding wire layer connected to each other, the third winding wire layer is between the first winding wire layer and the second winding wire layer in the height direction of the magnetic structure, and the second winding wire layer is between the third winding wire layer and the fourth winding wire layer in the height direction of the magnetic structure.

3. The coupled inductor of claim 2, wherein the insulating oxide film set comprises:
a first insulating oxide film sandwiched between the first winding wire layer and the third winding wire layer;
a second insulating oxide film sandwiched between the third winding wire layer and the second winding wire layer; and
a third insulating oxide film sandwiched between the second winding wire layer and the fourth winding wire layer.

4. The coupled inductor of claim 3, wherein a width of the first insulating oxide film is equal to a width of the first winding wire layer and a width of the third winding wire layer, a width of the second insulating oxide film is equal to the width of the third winding wire layer and a width of the second winding wire layer, and a width of the third insulating oxide film is equal to the width of the second winding wire layer and a width of the fourth winding wire layer.

5. The coupled inductor of claim 3, wherein a width of the first insulating oxide film is greater than a width of the first winding wire layer and a width of the third winding wire layer, a width of the second insulating oxide film is greater than the width of the third winding wire layer and a width of the second winding wire layer, and a width of the third insulating oxide film is greater than the width of the second winding wire layer and a width of the fourth winding wire layer.

6. The coupled inductor of claim 3, wherein the first insulating oxide film, the second insulating oxide film, and the third insulating oxide film completely pass through or partially pass through the magnetic core.

7. The coupled inductor of claim 3, wherein the first insulating oxide film, the second insulating oxide film, and the third insulating oxide film completely pass through the magnetic structure.

8. The coupled inductor of claim 3, wherein the first winding wire layer and the second winding wire layer are connected by a first bonding layer, which extends along the height direction of the magnetic structure.

9. The coupled inductor of claim 8, wherein the third winding wire layer and the fourth winding wire layer are connected by a second bonding layer, which extends along the height direction of the magnetic structure.

10. The coupled inductor of claim 9, wherein the first bonding layer is adjacent to the second bonding layer and opposite to the second bonding layer, wherein between the first bonding layer and the second bonding layer, the first winding wire layer and the fourth winding wire layer are opposite to each other, and the magnetic structure is between the first winding wire layer and the fourth winding wire layer, which are opposite to each other.
